(19) United States
(12) Patent Application Publication
(10) Pub. No.: US 2022/0073692 A1
(43) Pub. Date: Mar. 10, 2022

(54) METHOD FOR OBTAINING A ONE COMPONENT, OXYGEN CURABLE COMPOSITION

(71) Applicant: GREENSEAL NV, Deinze (BE)

(72) Inventors: Aster DE SCHRIJVER, Sint-Martens-Latem (BE); George GEORGIEV, Sofia (BG); Kevin HUVAERE, Tielt (BE)

(21) Appl. No.: 17/310,477

(22) PCT Filed: Feb. 5, 2020
(86) PCT No.: PCT/EP2020/052890

§ 371 Date: Aug. 5, 2021

(30) Foreign Application Priority Data
Feb. 6, 2019 (EP) 19155750.3

(51) Int. Cl. C08J 9/02; C08J 9/00; B65D 83/14

(52) U.S. Cl. CPC C08J 9/02; C08J 9/0052; C08J 9/0047; C08J 2207/04; C08J 2375/16; C08J 2367/07; C08J 2201/022; B65D 83/752

(57) ABSTRACT

A novel polymerizable composition, which can be used in 1K aerosol can systems for forming a foam, include a reactive precursor mixture, which is subjected to one or more deoxygenation measures so that it does not react during storage, and an alkyl metal compound, such as an organic borane compound as initiator. Since the initiation of the polymerization is enabled by oxygen, particularly oxygen from ambient air, the curing of the composition is not dependent on ambient moisture and proceeds even at low temperatures, including those below 0° C. The composition has a fast curing time when contacted with oxygen or air, and the resulting final cured product has a high quality.

### FIELD OF THE INVENTION

The present invention relates to methods to prepare an oxygen curable composition, particularly suitable for use as a one component (1C) composition, for instance as a 1C oxygen curable composition stored in aerosol type pressurized cans in sprayable foam applications. The present invention further provides one component, oxygen curable compositions and containers comprising such composition.

### BACKGROUND

In single component or one component foams, sealants or adhesives, the reactive components are premixed in their final proportions. However, they are chemically blocked and they will not cure, i.e. polymerize and/or crosslink, as long as they are not subject to the specific conditions which activate the curing mechanism. Several means to initiate the curing mechanism are known.

For instance, a polyurethane (PU) foam, comprising a mixture of polyols, diisocyanates, liquefied gases as blowing agents, and several additives, are cured by the reaction of the isocyanate terminated prepolymers with ambient moisture upon spraying. A first issue with such moisture curable formulations is that curing is triggered by the moisture present in the ambient air. This means that their crosslinking rates can vary from a rainy day to a sunny day, from generally humid regions to generally dry regions, and that such PU foams can even be useless in particularly dry atmospheres as can be encountered in continental or (semi-)desert climates. A second, quite major disadvantage of PU foam compositions is that isocyanates are toxic. Methylene Diphenyl Diisocyanate (MDI) is the isocyanate most commonly used in the production of PU foams. This compound, although the least hazardous of the isocyanate groups, is still toxic, harmful by inhalation or ingestion, and also via skin contact. In addition, the compound is flammable and can also be explosive.

Many compounds comprising vinyl functional groups, such as for instance acrylates and methacrylates, are polymerizable by free-radicals, wherein a polymer is formed by the successive addition of free-radical building blocks. Typically, specific initiator molecules are involved in the formation of the free-radicals. Since compositions comprising free-radically polymerizable compounds and initiator compounds are typically spontaneously reactive, it is common practice to provide them as a two-part system such as, for example, a part A and a part B that are combined immediately prior to use.

There thus remains a need for methods to obtain one component free-radically polymerizable compositions and for the corresponding one component free-radically polymerizable compositions. In particular, there remains a need for foam compositions suitable for being dispensed via pressurized containers, which are isocyanate free, which can be cured independent from moisture and under a wide range of temperatures, and which yield high quality products upon dispensing from the pressurized container.

### SUMMARY OF THE INVENTION

The inventors have developed methods to obtain a viscous, one component, oxygen-curable polymerizable compositions, such as for use as a foam, sealant or adhesive, comprising subjecting the polymerizable precursor mixture to a deoxygenation treatment. In particular, the inventors have developed a method to obtain a polymerizable precursor composition comprising a reactive precursor mixture and an oxygen sensitive initiator compound, wherein the initiation of the polymerization is enabled by oxygen, particularly oxygen from ambient air. Advantageously, the curing of the composition is not dependent on ambient moisture and proceeds even at low temperatures, below 0° C.

Surprisingly, in the viscous polymerizable composition envisaged herein, the reactive precursors and the oxygen sensitive curing initiator compound may be mixed and stored without polymerization, until the composition is brought into contact with air and is subsequently rapidly cured. By implementing one or more deoxygenation measures, the composition, such as when contained in a pressurized container for foam applications, is essentially oxygen free and will not react during storage, even though the oxygen sensitive radical initiator and the reactive precursor mix are in contact with each other, as in one component foam, sealant or adhesive applications. This way, a long shelf life stability is ensured. Advantageously, the compositions of the present invention have a short curing time when contacted with oxygen or air, and the resulting final cured product has a high quality.

A first aspect of the present invention provides a method for preparing a one component, oxygen-curable precursor composition, comprising the steps of (i) preparing or providing a viscous reactive precursor mixture, wherein the reactive precursor mixture comprises at least one free-radically polymerizable monomer and/or oligomer; (ii) subjecting the reactive precursor mixture to a deoxygenation treatment, thereby obtaining a deoxygenated reactive precursor mixture; (iii) adding an oxygen scavenger to the deoxygenated reactive precursor mixture, and subsequently (iv) adding an organometal or organoborane compound radical initiator to the deoxygenated reactive precursor mixture.

In preferred embodiments, the deoxygenation treatment of step (ii) comprises subjecting the reactive precursor mixture to one or more deoxygenation cycles, wherein each deoxygenation cycle comprises degassing the reactive precursor mixture by subjecting it to a vacuum and subsequently purging or flushing the degassed reactive precursor mixture with an inert gas. In particular, the reactive precursor mixture as envisaged herein is a highly viscous, non-Newtonian fluid, with viscosities of at least 3500 cP, such as between 4000 and 5000 cP or higher.

In preferred embodiments, step (i) comprises preparing or providing a reactive precursor mixture, wherein the reactive precursor mixture comprises at least one ethylenically unsaturated compound having at least one free-radically polymerizable carbon-carbon double bond, preferably having 1 to 10 free-radically polymerizable carbon-carbon double bonds. In particular embodiments, the at least one ethylenically unsaturated compound is a vinyl compound, preferably an acrylate or methacrylate compound, an allyl ether compound or a styrene compound. In more particular embodiments, step (i) comprises preparing or providing a reactive precursor mixture, wherein the reactive precursor mixture comprises a urethane and/or polyester (meth)acrylate compound with 1 to 6 vinyl moieties.

In preferred embodiments, step (i) comprises preparing or providing a reactive precursor mixture, wherein the reactive precursor mixture comprises at least one free-radically polymerizable monomer and/or oligomer as envisaged herein, and at least one reactive diluent, wherein the reactive diluent preferably comprises free-radically polymerizable monomer having 1 to 4 unsaturated free-radically polymerizable groups or carbon-carbon double bonds, preferably having 1 to 4 vinyl functional groups. In other preferred embodiments, the reactive precursor mixture further comprises an anaerobic radical scavenger. In certain embodiments, the reactive precursor mixture further comprises one or more additives, such as a stabilizer, a flame retardant, a surfactant, a propellant or blowing agent, a colorant, . . . .

In preferred embodiments, the organometal or organoborane compound in step (iv) is an alkyl- or alkoxy-metal or an alkyl- or alkoxyborane compound.

In particular embodiments, the method as envisaged herein further comprises (v) filling a container with the deoxygenated reactive precursor mixture comprising an oxygen scavenger and, optionally, pressurizing the container by adding a blowing agent or propellant.

Another aspect of the present invention relates to a one-component, oxygen-curable precursor composition, obtainable by a method according to the present invention. In particular, the one-component, oxygen-curable precursor composition as envisaged herein, comprises (a) a deoxygenated reactive precursor mixture, comprising at least one ethylenically unsaturated compound having 1 to 10 free-radically polymerizable carbon-carbon double bonds, preferably wherein said at least one ethylenically unsaturated compound is a vinyl compound; (b) an oxygen scavenger; (c) an organometal or organoborane compound as radical initiator; and (d) preferably, an anaerobic radical scavenger; wherein the precursor composition comprises less than 1 ppm oxygen. In certain preferred embodiments, the oxygen-curable precursor composition is an isocyanate-free foam precursor composition, comprising a deoxygenated reactive precursor mixture, comprising a urethane and/or polyester (meth)acrylate compound with 1 to 6 vinyl moieties and a diluent comprising a (meth)acrylate functionalized monomer with 1 to 4 vinyl moieties; an oxygen scavenger; an organometal or organoborane compound as radical initiator; and, preferably, an anaerobic radical scavenger, wherein the precursor composition comprises less than 1 ppm oxygen. In particular, the one-component, oxygen-curable precursor composition as envisaged herein is a highly viscous, non-Newtonian fluid, with viscosities of at least 3500 cP, such as between 4000 and 5000 cP or higher.

Another aspect of the present invention relates to a container, such as a pressurized container, comprising a composition according to the present invention.

Yet another aspect of the present invention relates to the use of the composition according to the present invention as a one component sprayable foam composition, a one component sealant or a one component adhesive.

### BRIEF DESCRIPTION OF THE FIGURES

FIG. 1 represents the direct radical curing pathway for a reactive precursor composition according to an embodiment of the present invention. Initiation: The curing is initiated by organic (such as alkyl or alkoxyl) radicals generated from an organic borane compound, e.g. trialkylborane, and oxygen (from ambient air). Polymerization: the polymer chains are propagated when a radical reacts with a reactive precursor to produce a (radical) polymer chain. Chain growth is terminated when two radicals react with each other to create a non-radical product or via a radical disproportionation reaction, particularly when the recombination is sterically hindered, wherein two radicals react to form two different non-radical products.

FIG. 2 shows a laboratory device suitable for performing the deoxygenation of the reactive precursor.

FIG. 3 shows the reaction between MDI and HPMA to form an NCO-terminated prepolymer of HPMA with MDI, in the preparation of an aromatic urethane methacrylate blend as envisaged in certain embodiments of the present invention.

FIG. 4 shows the preparation of double acrylized MDI from MDI and an excess of HPMA, in the preparation of an aromatic urethane methacrylate blend as envisaged in certain embodiments of the present invention.

FIG. 5 shows the reaction between an NCO-terminated prepolymer and 2-ethyl hexanol, in the preparation of an aromatic urethane methacrylate blend as envisaged in certain embodiments of the present invention.

FIG. 6 shows the reaction between IPDI and HPMA to form an NCO-terminated prepolymer of HPMA with IPDI, in the preparation of an aliphatic urethane methacrylate blend as envisaged in certain embodiments of the present invention.

FIG. 7 shows the structure of double acrylized IPDI, obtained from the reaction between IPDI and an excess of HPMA, in the preparation of an aliphatic urethane methacrylate blend as envisaged in certain embodiments of the present invention.

FIG. 8 shows the structure of an aliphatic urethane methacrylate with glycerol, obtained from the reaction between an NCO-terminated prepolymer and glycerol, in particular an urethane prepolymer of HPMA with IPDI, reacted with glycerol, in the preparation of an aliphatic urethane methacrylate blend as envisaged in certain embodiments of the present invention.

### DETAILED DESCRIPTION

The present invention will be described with respect to particular embodiments but the invention is not limited thereto but only by the claims. Any reference signs in the claims shall not be construed as limiting the scope thereof.

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” when referring to recited members, elements or method steps also include embodiments which “consist of” said recited members, elements or method steps.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The term “about” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” refers is itself also specifically, and preferably, disclosed.

The recitation of numerical ranges by endpoints includes all numbers and fractions subsumed within the respective ranges, as well as the recited endpoints.

All documents cited in the present specification are hereby incorporated by reference in their entirety.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

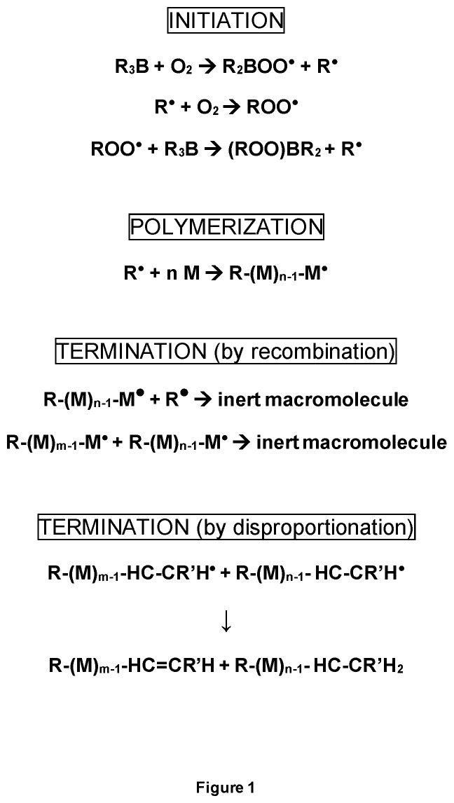

The inventors have developed novel polymerizable precursor compositions, particularly one component, oxygen-curable precursor compositions, and novel methods to prepare such compositions. In general, the present invention concerns a system, comprising a composition containing a reactive precursor mixture and an oxygen-sensitive radical initiator, wherein the curing of the reactive precursor is initiated by the generation of radicals, enabled by oxygen from the air, and further comprising implementing procedures to ensure the chemical stability of the composition prior to its application (e.g. when stored in a container), i.e. by excluding the presence of oxygen in the composition, and to ensure the proper functioning of the system upon activation by oxygen from air. Surprisingly, by implementing one or more deoxygenation measures envisaged herein, the reactive precursor compounds and the radical initiator compound may be mixed and stored together without curing, until the composition is brought into contact with air and is subsequently rapidly cured. In this context, the compositions as envisaged herein are highly viscous, non-Newtonian fluids, with viscosities of at least 3500 cP, such as between 4000 and 5000 cP or higher. Removal of dissolved or emulsified oxygen from such highly viscous compositions is complex and difficult to achieve. The deoxygenation measures as envisaged herein ensure that the composition, such as when contained in a container, is essentially oxygen free and will not react during storage, even though the radical initiator and the reactive precursor mix are in contact with each other, as in one component foam, sealant or adhesive applications. This way, a long shelf life stability is ensured. Advantageously, the compositions of the present invention have a short curing time when contacted with oxygen or air. The present invention thus concerns oxygen-activated self-curing polymerizable compositions comprising both radical-sensitive precursor compounds and a radical initiator, wherein the compositions are inert and do not polymerize during storage, but are activated and polymerize when, upon dispensing, in contact with oxygen from air. The crosslinking or curing system proposed in the present invention is a radical addition type crosslinking polymerization reaction and is schematically shown in FIG. 1. It can be considered as an alternative for the moisture induced curing of other systems, such as the moisture curing of isocyanate-based compositions.

A first aspect of the present invention provides for a method for preparing an oxygen-curable precursor composition, particularly a one component, oxygen-curable precursor composition, such as for use as a foam, sealant or adhesive, which has been subjected to a deoxygenation treatment. In particular, the present invention provides for a method for preparing an oxygen-curable precursor composition, particularly a one component, oxygen-curable precursor composition, comprising the steps of (i) preparing or providing a reactive precursor mixture, wherein the reactive precursor mixture comprises at least one free-radically polymerizable monomer and/or oligomer; (ii) subjecting the reactive precursor mixture to a deoxygenation treatment, thereby obtaining a deoxygenated reactive precursor mixture; (iii) adding an oxygen scavenger to the deoxygenated reactive precursor mixture, and subsequently (iv) adding an oxygen-sensitive radical initiator, particularly an organometal or organoborane compound radical initiator, to the deoxygenated reactive precursor mixture.

The reactive precursor mixture as envisaged herein comprises reactive oligomers and monomers, which are transformed upon curing in the final product. The oligomers used in the present invention preferably have unsaturated backbones with reactive groups and different functionalities i.e. they are monofunctional, difunctional, trifunctional, multifunctional or mixtures of several types and different molecular weight. The reactive precursor mixture as envisaged herein generally contains monomeric and oligomeric compounds, particularly unsaturated monomeric and oligomeric compounds, which are able to polymerize and crosslink via a radical addition reaction. Stated differently, the reactive precursor mixture comprises at least one free-radically polymerizable monomer and/or oligomer. Free-radically polymerizable compounds, in particular monomers and oligomers that can polymerize and/or crosslink by free radical polymerization, are known to the skilled person. Suitable compounds include ethylenically-unsaturated compounds having at least one free-radically polymerizable carbon-carbon double bond per molecule, preferably having 1 to 10 free-radically polymerizable carbon-carbon double bonds per molecule, such as 2 to 10 or 3 to 10 free-radically polymerizable carbon-carbon double bonds per molecule. In addition, the reactive precursor mixture as envisaged herein is a highly viscous fluid, particularly a highly viscous, non-Newtonian fluid. More in particular, the viscosity of the reactive precursor mixture is at least 3500 cP, such as between 4000 and 5000 cP or even higher. Any technique known to the skilled person may be used to determine the viscosity, for instance using a viscometer comprising rotating spindles, such as produced by Brookfield.

In particular embodiments, the ethylenically-unsaturated compounds, particularly ethylenically-unsaturated monomers and/or oligomers, may be selected from the acrylates, methacrylates, styrene, maleate esters, fumarate esters, unsaturated polyester resins, alkyd resins, thiolene compositions, and/or acrylate, methacrylate or vinyl terminated resins, including acrylate, methacrylate or vinyl terminated silicones and urethanes.

In particular embodiments, the at least one ethylenically-unsaturated compound present in the reactive precursor mixture is a vinyl compound. Vinyl compounds, such as acrylates and methacrylates, acrylamides and methacrylamides, allyl ethers, and styrenes, are polymerizable by free-radicals. As used herein, the prefix “(meth)acryl” refers to acryl and/or methacryl. For example, (meth)acrylate refers to acrylate and/or methacrylate. Examples of suitable free-radically polymerizable vinyl compounds include vinyl esters such as diallyl phthalate, diallyl maleate, diallyl succinate, diallyl adipate, diallyl azelate, diallyl suberate, and other divinyl derivatives thereof. Other suitable free-radically polymerizable compounds include siloxane-functional (meth)acrylates.

The free-radically polymerizable double bonds are particularly preferably present in the form of (meth)acryloyl groups. Examples of prepolymers or oligomers include (meth)acryloyl-functional poly(meth)acrylates, urethane (meth)acrylates, polyester (meth)acrylates, unsaturated polyesters, polyether (meth)acrylates, silicone (meth)acrylates, epoxy (meth)acrylates, amino (meth)acrylates and melamine (meth)acrylates.

In particular embodiments, the reactive precursor mixture comprises a urethane and/or polyester (meth)acrylate compound with 1 to 6 vinyl moieties.

In certain embodiments, the reactive precursor mixture further comprises an unsaturated polyester resin (USPER). In foam applications, USPER compounds contribute to the foaming properties of the composition after dispensing, such as foam resilience, and also allow to reduce the price of the foam. Unsaturated polymers include polyesters like polyethylene terphtalate and polyethers like polyethylene glycol. Any polymer with a (poly)ester backbone and possessing some amount of double bonds may be utilized to some extend and is therefore included in the broad definition of an unsaturated polyester resin. In preferred embodiments, the unsaturated polyester resin (USPER) comprises an unsaturated polyester resin, obtained by polyesterification of a glycol and an anhydride, as known in the art, and diluted or dissolved in a blend of reactive diluents as taught herein. Particularly, said glycol is i-propylene glycol. Particularly, the anhydride is a blend of anhydrides, preferably a blend of maleic and o-phthalic anhydrides. In general, the so prepared USPER is used for diluting the more expensive components of the reactive precursor mixture, without affecting the consistence and quality of the resulting product (foam).

The free-radically polymerizable monomers and/or oligomers as envisaged herein may be used in combination with reactive diluents having one or more unsaturated free-radically polymerizable groups, such as having 1 to 4 unsaturated free-radically polymerizable groups or carbon-carbon double bonds.

Reactive diluent is used herein according to the definition of DIN 55945:1996-09, which defines such substances as diluents which react chemically during curing to become a constituent of the product. Reactive diluents may be mono-, di- or polyfunctional free-radically polymerizable monomeric compounds, preferably, having (meth)acryloyl groups. The reactive diluents are of low molecular weight and have, for example, a molar mass of below 500 g/mol.

The reactive diluent typically controls the viscosity of the reactive precursor mixture and to a proper functioning of the composition during application. In foam application, the diluents may advantageously also increase the solubility of a propellant or blowing agent in the reactive precursor mixture, resulting in an improved physical structure of the foam after the composition according to the present application is dispensed from a pressurized container. The reactive diluent also contributes to the foam resilience, with, for instance, iBoMA contributing to a more rigid foam, and 2-EHMA to a more soft foam. Also, reactive diluents with vinyl functionality of 2 or higher contribute to an increased cross-linking density. Exemplary reactive diluents include (meth-)acrylic esters of polyols, such as a blend of 1,6 hexanediol diacrylate (1,6 HDDA), tripropyleneglycol diacrylate (TPGDA), iso-bomyl methacrylate (iBoMA) and/or 2-ethylhexyl methacrylate (2-EHMA), most preferably a blend of TPGDA and 2-EHMA. In certain embodiments, an unsaturated polyester resin may be dissolved in a reactive diluent, such as in 1,6 hexanediol diacrylate (1,6 HDDA) and/or tripropyIeneglycol diacrylate (TPGDA), most preferably TPGDA.

In certain embodiments, the methods according to the present invention further comprise the step of preparing the ethylenically-unsaturated monomers and/or oligomers having at least one free-radically polymerizable carbon-carbon double bond per molecule, such as by preparing a vinyl derivative, preferably a (meth)acryl derivative of a suitable compound.

To ensure that the oxygen sensitive organometal or organoborane radical initiator compound in the composition remains unreactive prior to application, such as when stored in a closed container, and that polymerisation and crosslinking only occurs upon dispensing the composition, the present application envisages several measures to remove the oxygen from the composition, or, stated differently, to control/limit the oxygen content in the composition according to the present invention to below 1 ppm, preferably below 0.5 or 0.1 pm. Preferred deoxygenation measures include a physical deoxygenation treatment in combination with the use of an oxygen scavenger. In particular embodiments, the reactive precursor mixture is subjected to a physical deoxygenation treatment, as set out below, which is combined with the addition of an oxygen scavenger.

In particular embodiments, the step of subjecting the reactive precursor mixture to a deoxygenation treatment, in particular a physical deoxygenation treatment, comprises subjecting the reactive precursor mixture to consecutive cycles, also referred to as deoxygenation cycles, of subjecting the reactive precursor mixture to alternating degassing treatments, particularly degassing treatments by vacuum, and saturation treatments by an inert gas. Thus, each deoxygenation cycle comprises degassing the reactive precursor mixture by subjecting it to a vacuum and subsequently purging or flushing the degassed reactive precursor mixture with an inert gas.

Preferably, the deoxygenation treatment comprises subjecting the reactive precursor mixture to a number of treatment cycles, from 4 to 8, preferably 4 to 6, such as 4 to 5, with each cycle made up of vacuum treatment followed by a saturation or flushing of the reactive precursor mixture with an inert gas, such as CO₂ or N₂. Advantageously, this way, both the oxygen level in the reactive precursor mixture as well as the variability of the oxygen level are reduced significantly, to the extent that, in practice, the residual oxygen content in the reactive precursor mixture can be regarded as being a constant, extremely low value, thus allowing the addition of standardized (stoichiometric) levels of oxygen scavenger for the further reduction or complete removal of the oxygen in the reactive precursor mixture.

In particular embodiments, the vacuum treatment is a standardized vacuum treatment with specific vacuum level, temperature and treatment time.

In particular embodiments, the saturation or flushing treatment is a standardized saturation or flushing of the reactive precursor mixture with an inert gas, such as nitrogen gas or CO₂, with specific pressure, temperature and treatment time.

Advantageously, the optimal number of (standardized) cycles can be experimentally determined to reduce the oxygen content to the lowest level for the used equipment with minimum deviations (in case of accidental variation of the vacuum level upon processing), i.e. to a substantially standard or constant low level. The saturation step with an inert gas aims to recover the initial gas pressure of the reactive precursor mixture, albeit with an inert gas instead of air. In addition, the saturation step with an inert gas effectively results in the dilution of the air remaining in the reactive precursor mixture. Combining multiple, alternating vacuum and saturation treatments, as envisaged herein, allows to reduce the oxygen content to almost ignorable values as well as to reduce the variability of the oxygen content remaining in the reactive precursor mixture.

Indeed, for example, if after a first vacuum degassing treatment, the air (and oxygen) content of the reactive precursor mixture is reduced with approximately 90%, i.e. the remaining content air will be 10% of the initial situation. Via flushing with an inert gas, this is “diluted” to the same gas volume as initially present in the reactive precursor mixture. A second deoxygenation cycle, will reduce the air content to approximately 1% (diluted by 99% inert gas in the same volume), and a third and fourth deoxygenation cycle will reduce the air content to about 0.1% and 0.01%, respectively. With increasing treatment cycles, the absolute value of the deviation of the oxygen content deviation will become ignorable small, independent of the (unknown) initial content of oxygen (before the treatments) in the reactive precursor mixture. Accordingly, in this way, the obtained low level of oxygen can be seen as a standardised and constant value, as all deoxygenation treatments with the same characteristics on a precursor mixture will lead to the same result with ignorable deviation, even when the viscous nature of the composition is taken into account, which makes it very difficult to determine the oxygen content analytically, and to remove all oxygen via a physical deoxygenation treatment, particularly in view of the desired long term stability of the composition.

In particular embodiments, the vacuum treatment comprises subjecting the reactive precursor mixture to a vacuum, particularly at room temperature, by using a vacuum pump to create a vacuum. In certain embodiments, the vacuum treatment is performed with a rotary vacuum pump. Initially, at high gas content in the liquid, the pump flow rate is high. With decreasing gas content, the pump flow rate diminishes as well and lower vacuum levels are reached, until the pump flow rate approaches zero. At this stage, the vacuum treatment is ended and saturation with an inert gas is initiated. For instance, a vacuum pump may be selected allowing to remove in about 1 hour at least 80-90% of the air or inert gas content in the reactive precursor mixture. Advantageously, as each vacuum treatment step is followed by the saturation of the reactive precursor mixture by an inert gas, each vacuum treatment starts with a gas saturated precursor mixture at about atmospheric pressure, thus allowing to evacuate, in each cycle, the same gas volume, contributing to the reproducibility of the vacuum treatment.

In particular embodiments, the saturation or flushing of the degassed (by vacuum) reactive precursor mixture comprises introducing an inert gas, particularly at a pressure of about 1.0 to 2.0 bar, such as about 1.0 to 1.5 bar, preferably about 1.2 bar, in the vacuum degassed reactive precursor mixture, particularly for about 1 h at room temperature.

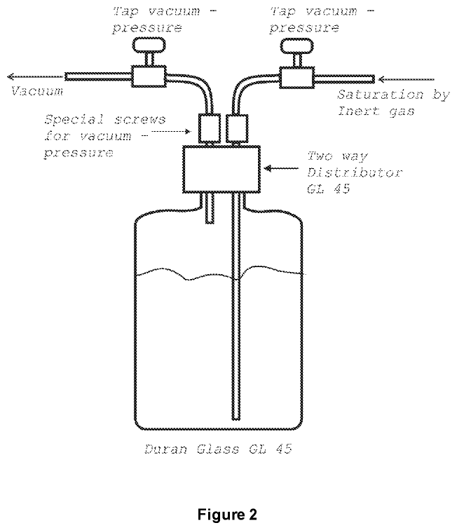

In certain embodiments, the deoxygenation treatment is performed using the device shown in FIG. 2. During the vacuum degassing, the valve of the vacuum line is open and the valve of the inert gas line is closed, thus allowing a vacuum pump to remove the gas from the reactive precursor mixture. After a predetermined time, the valve of the vacuum line is closed and the valve of the inert gas line is opened, thus introducing an inert gas in the reactive precursor mixture.

In step (iii) of the method as envisaged herein, the physical deoxygenation treatment is followed by the addition of an oxygen scavenger to the deoxygenated reactive precursor mixture. It is understood that after the deoxygenation treatment of the reactive precursor mixture, all other operations on the reactive precursor mixture, such as filling the composition in containers, are performed in inert (anaerobic) atmosphere.

In this context, the physical deoxygenation treatment based on repetitive cycles of pressure reduction followed by inert gas purging does not bring oxygen levels below the threshold needed for leaving the oxygen-sensitive initiator unreactive. Most likely, due to the highly viscous nature of the reactive precursor mixture, some oxygen remains in the high viscosity medium, presumably in emulsifled form. Applying a chemical oxygen scavenger after the physical deoxygenation process is a complementary approach to remove final residues of oxygen. The scavenger preferably consumes dissolved or emulsified oxygen from the viscous liquid without producing reactive species, such as radicals, that destabilize the formulation, e.g. by premature curing.

An oxygen scavenger as envisaged herein is a compound capable of reacting with oxygen which has at least substantially the same, preferably a higher, efficiency of accepting oxygen than the organometal or organoborane radical initiator. In particular, it is soluble in the reactive diluent. Advantageously, the presence of an oxygen scavenger ensures that, during storage, the composition remains anaerobic or oxygen-free, i.e. that the oxygen content of the composition remains below 1 ppm or even below 0.5 or 0.1 ppm and thus remains too low to react with the radical initiator compound, thus preventing the generation of radicals and the polymerization or curing of the reactive precursor mixture.

In particular embodiments, the oxygen scavenger is methylethylketoxyme (MEKO), erythorbic acid or hydroquinone, in particular at a level of 10 to 500 ppm, preferably 10 to 400 ppm or 10 to 300 ppm. Borane hydrides, such as monoalkylboradihydride, borane or trihydroboron (BH₃) and diborane (B₂He) are suitable as well. These compounds are more sensitive to oxygen than the trialkyborane radical initator, but they do not generate radicals upon reaction with oxygen.

An oxygen scavenger useful for this application is borane, also known as trihydroboron, and with the chemical formula BH₃. The boron atom carries 6 valence electrons and thus not meet the octet rule hence it behaves as strong Lewis acid that instantly reacts with a Lewis base, thus explaining its reactivity with water and oxygen. The parent compound, diborane B₂H₆ is an inflammable gas with similar high reactivity to air and moisture. Boranes may also be generated in situ via various reactions, for example by acidifying or by mild oxidation of sodium borohydride. Borane hydrides or dborane are typically added in the range of 1 to 100 ppm, such as 1 to 50 ppm, 1 to 30 ppm or even 1 to 20 ppm.

In particular embodiments, the oxygen scavenger is present in an amount which is sufficient to prevent the curing of the composition during storage, i.e. to prevent the oxygen-mediated generation of radicals by the initiator compound, and which, at the same time, does not affect the curing of the composition after dispensing.

As the elimination of oxygen by the oxygen scavenger is stoichiometric, the amount of oxygen scavenger in the reactive precursor mixture is at least the amount of remaining oxygen in the reactive precursor mixture, particularly is at least more than the amount of remaining oxygen. However, the composition according to the present invention, particularly the reactive precursor mixture, is a relative high viscous system, making it very difficult to determine the oxygen content analytically, and to remove all oxygen via a physical deoxygenation treatment, particularly in view of the desired long term stability of the composition. Accordingly, in preferred embodiments, the amount of oxygen scavenger is added in a sufficient excess to ensure that the organometal or organoborane initiator remains inactive during storage, without affecting the curing upon dispensing. This is particularly relevant for foaming applications. Indeed, in the case of classic one component PU foams, the secondary gas release during curing alows a prolonged solidification time as a stationary state of curing and froth expansion is established. In contrast, the stationary state of curing and expansion in the case of the radically curing reactive precursor mixture according to the present invention is considerably shorter as the secondary gas release is missing. Accordingly, a satisfactory cell structure of the foam, its dimensional stability and adhesion, and the like, need to be obtained in a much shorter time. In general, the amount of oxygen scavenger present in the composition is in accordance with its oxygen content, with some excess to block accidental, unwanted traces of oxygen, which may penetrate into the container, particularly during longer storage times. If a too large excess of oxygen scavenger is present, it will delay the solidification of the composition after dispensing, which will reflex unfavorably on the foam characteristics and quality.

Advantageously, the optimum content of the oxygen scavenger may be determined experimentally, such as by preparing several series of containers comprising the composition according to the present invention with varying oxygen scavenger levels but with the same amount of the same radical initiator, and subsequently assessing the shelf life of the closed containers and the quality and curing time of the composition (e.g. foam) when the composition is dispensed in the air. Such experimental determination is particularly useful when the deoxygenation treatments are standardized by using the same equipment.

The oxygen scavenger is added to a deoxygenated reactive precursor mixture, or stated differently, to a reactive precursor which has been subject to a series of physical deoxygenation steps, thereby reducing the oxygen content to a large extent, e.g. by at least 80%, 90%, 95%, 97% or even more than 99%. This deoxygenation step allows to add only low levels of oxygen scavenger, which ensures that the composition of the present invention does not cure when stored in the container and maintain its fast curing rate and thus a good final foam quality upon dispensing.

Preferably, the oxygen scavenger, such as a borane or diborane compound, is present in the reactive precursor mixture in an amount comprised between 1 and 2000 ppm or between 1 and 1000 ppm, preferably between 1 and 500 ppm, between 1 and 300 ppm or between 1 and 100 ppm.

The radical initiator compound envisaged in the present application is an oxygen-activated free-radical generating compound. In particular, the radical initiator compound envisaged in the present application is an organometal or organoborane compound which generates organic radicals when exposed to oxygen, preferably oxygen from the ambient air, thus initiating the curing of the reactive precursor mixture blend via a direct radical addition type curing mechanism. Preferably, the radical initiator is an organoborane compound. In particular, the borane compound may be an alkyl- or alkoxy-borane of formula (alkoxy)₃-B-(alkyl)ₙ, with n=0 to 3, and wherein alkyl and alkoxy each independently comprise a carbon chain comprising between 1 and 14 C atoms. In particular, the borane compound is a trialkyl borane, and may be selected among the group of trimethylborane, triethyborane, tripropyborane, tributyIborane, tri-seo-butyborane, trihexylborane, trioctylborane, tridecyborane, tritridecyborane. triethyborane, methoxydiethyborane, and tributyborane are preferred borane compounds. The organometal or organoborane radical initiator is generally present in an amount effective for initiating/activating the polymerisation of the composition upon exposure to atmospheric oxygen. Preferably, the organometal or organoborane compound is present in an amount comprised between 0.1 and 10 wt. %, with respect to the total weight of reactive precursor mixture, preferably between 0.1 and 6 wt. %, more preferably between 0.1 and 2 wt %. In preferred embodiments, in addition to the organometal or organoborane compound described herein, a small amount of acid is added to the reactive precursor mixture, in particular between 1 and 200 ppm, preferably between 1 and 100 ppm or between 1 and 50 ppm) of phenylphosphonic acid, pyrogallol or a suitable Lewis acid.

Advantageously, with an organometal radical initiator or an organoborane initiator, the curing kinetics of the reactive precursor mixture are not dependent on the weather and climate of the place of application and is constant regardless of the moisture content of the atmosphere. Another great advantage is that the product can also cure at temperatures below freezing point.

It is understood that the initiating or curing activating system comprising an organometal or organoborane radical generating compound as described herein occurs in two modes, i.e. a passive mode and an active mode.

The passive mode corresponds to the situation during storage of the oxygen-curable precursor composition prior to its application, such as when stored in a container, such as in a pressurized container for foam applications. In this mode, polymerization and curing of the composition is unwanted and the initiating system needs to be inactive. This is ensured by the oxygen-curable precursor composition as envisaged herein containing only traces of oxygen, below a maximum permissible concentration, lower than the sensitivity of the reaction of the radical initiator and oxygen. In order to ensure the passive mode of the radical initiator system, measures are implemented for the deoxygenation of the oxygen-curable precursor composition, particularly the reactive precursor mixture. As detailed above, several deoxygenation measures are envisaged, including a series of physical deoxygenation treatments of the oxygen-curable precursor composition, and the use of an oxygen scavenger to capture the final traces of oxygen in the oxygen-curable precursor composition. It is understood that due to the implementation of the deoxygenation measures, in particular a physical deoxygenation treatment in combination with the use of an oxygen scavenger, a one component composition can be obtained wherein the initiator is not encapsulated, but is freely mixed within the reactive precursor mixture.

The active mode corresponds to the situation after dispensing the oxygen-curable precursor composition from the container wherein it is stored, wherein the initiating system is activated by the oxygen from the air. Upon contact with ambient oxygen, the radical initiator compound will quickly release free organic radicals, independent of the ambient temperature, thus resulting in the curing of the dispensed foam precursor mixture.

In particular embodiments, the method further comprises adding an anaerobic radical scavenger to the reactive precursor mixture as envisaged herein. An anaerobic radical scavenger as envisaged herein is a compound capable of capturing accidently occurring free radicals during storage, before application, for preventing the curing of the foam precursor composition under anaerobic conditions. Although the use of radical scavengers in compositions containing compounds with vinyl functional groups to prevent unwanted polymerization or curing of such composition is known, many of such radical scavengers require some oxygen to be efficient, and are thus not suitable in the deoxygenated and anaerobic composition envisaged herein. A preferred anaerobic radical scavenger is phenothiazine. Preferably, the anaerobic radical scavenger is present in the reactive precursor mixture in an amount comprised between 50 and 700 ppm, preferably between 100 and 500 ppm, more preferably between 150 and 350 ppm, or between 250 and 350 ppm.

In particular embodiments, the method further comprises adding one or more other additives to the reactive precursor mixture, including but not limited to rheology modifiers, plasticizers, flame retardants, crosslinkers, blowing agents, surfactants, tackifiers, colorants and the like. These compounds are added in a concentration between 0.01 to 10% by weight of the total mixture, more preferably between 1 and 8 wt %. Preferred additives include one or more of the following:
a flame retardant, such as tris(2-chloroisopropyl)phosphate (TCPP);
a surfactant, preferably a non-ionic surfactant, more preferably a silicone surfactant, such as Tegostab® available from Evonik Industries or Vorasurf available from Dow Chemicals.
a diluent for the organometal or organoborane initiator compound, such as monoethylene glycol (MEG).

In certain embodiments, the methods for preparing a one component, oxygen-curable precursor composition as envisaged herein further comprises the step of filling a container with the deoxygenated precursor composition or with the one component, oxygen-curable precursor composition, in particular with the deoxygenated reactive precursor mixture, optionally comprising one or more additives, such as an oxygen scavenger, anaerobic radical inhibitor, surfactant, flame retardant and the like.

Particular embodiments of the present application provide a method to prepare a foam precursor composition, particularly a method to prepare a container, preferably a pressurized container, containing the foam precursor composition, wherein the method comprises the steps of (i) providing a reactive precursor mixture, comprising a urethane (meth)acrylate with 1 to 6 vinyl moieties, preferably an unsaturated poly-ester resin, and a diluent comprising a (meth)acrylate functionalized monomer with 1 to 4 vinyl moieties, and, (ii) subjecting the reactive precursor mixture to a deoxygenation treatment as described herein; and (iii) adding, in sequence, an oxygen scavenger as described herein to the deoxygenated reactive precursor mixture and an organometal or organoborane radical initiator compound as described herein to the deoxygenated reactive precursor mixture. In particular, a blowing agent or propellant is further added to the reactive precursor mixture to create a pressurized system, such as a pressurized container system or aerosol system, which allows spraying of the foam precursor composition into a curing froth, resulting in stable foam. Several blowing agents, typical liquefied petroieum gases like butane, propane, isobutane, dimethylether, isobutene and haiogenated compounds can be used. Preferably, the blowing agent or propellant comprises i-butane and DME. These gases have some typical characteristics such as the amount of dissolution of the resins in the liquid phase, boiling temperature and vapour pressure in the can in order to create an ideal mixture for the foam formulation. Typically, the propellants or blowing agents are introduced in the range of 50 to 60 vol %, based on the volume of the reactive precursor mixture.

In certain embodiments, the methods for preparing a foam precursor composition as envisaged herein, further comprises the step of filling a container with the deoxygenated foam precursor composition, in particular with the deoxygenated reactive precursor mixture, optionally comprising one or more additives, such as an oxygen scavenger, anaerobic radical inhibitor, surfactant, flame retardant and the like. In particular embodiments, the methods comprise the step of filling a container with the deoxygenated reactive precursor mixture, and subsequently closing the container, adding a propellant or blowing agent to the container, such as by injection, and finally adding the organometal or organoborane radical initiator.

In some embodiments, the method to prepare a container containing a foam precursor composition comprises the steps of (i) providing a reactive precursor mixture as envisaged herein; (ii) subjecting the reactive precursor mixture to the physical deoxygenation treatment as described herein process to remove the bulk of oxygen; (iii) transferring the deoxygenated reactive precursor mixture to an aerosol can that was purged with an inert gas to remove remaining air; (iv) adding/charging propellant and/or inert gas, in particular to lower initial viscosity; (v) adding a borane or diborane oxygen scavenger to the mixture in the aerosol can, in particular in an amount corresponding to a minimum excess of borane vis-&-vis the residual oxygen content to avoid interference in the later curing mechanism; and (vi) after an appropriate reaction time in which the borane reacts with the residual oxygen in the deoxygenated reactive precursor mixture in a non-radical process thereby forming innocuous borinate esters, introducing the alkyl borane initiator in the aerosol can. Alternatively, the borane or diborane oxygen scavenger is added to the reactive precursor mixture prior to its introduction in the aerosol can.

Another aspect of the present invention provides a novel one-component, oxygen curable, polymerizable precursor composition, comprising a reactive precursor mixture as envisaged herein and a suitable initiator, wherein the reactive precursor mixture comprises at least one monomeric and oligomeric free-radically polymerizable compounds, particularly at least one unsaturated monomeric and oligomeric compounds, which are able to polymerize and crosslink via a radical addition reaction, and wherein the initiator is a compound generating radicals, particularly in the presence of oxygen, for initiating the addition type crosslinking polymerization reaction. Particularly, the novel one-component, oxygen curable composition is obtainable by an embodiment of the method according to the present invention.

In particular embodiments, to avoid unwanted polymerization before application, such as when it is stored in a container, the composition comprises a deoxygenated reactive precursor mixture, wherein the composition has an oxygen content of less than 1 ppm, preferably less than 0.5 or 0.1 ppm. Additionally, the composition as described herein further comprises an oxygen scavenger. Advantageously, the incorporation of an oxygen scavenger in the composition according to the present invention, particularly in combination with a deoxygenation treatment thereof, ensures that the initiator compound cannot generate radicals during storage, even though they are in contact with each other during storage. This ensures that the polymerization reaction is not initiated prior to application resulting in a prolonged shelf life stability. In addition, despite the presence of an oxygen scavenger in the mixture, upon application, the curing of the composition by oxygen is not affected. More in particular, the combination of a deoxygenation treatment of the reactive precursor mixture as described herein below and low levels of oxygen scavenger in the composition results in a fast chemical curing upon application, i.e. upon exposure of the composition with the oxygen in the air.

In particular embodiments, the present invention relates to an oxygen-curable precursor composition, particularly stored in a container, such as a pressurized container or aerosol can, comprising (i) a reactive precursor mixture as described herein, and (ii) a radical initiator, particularly an organometal or organoborane radical initiator, wherein the composition has an oxygen content of less than 1 ppm, preferably less than 0.5 or 0.1 ppm. Preferably, the oxygen-curable precursor composition further comprises (iii) an oxygen scavenger as described herein and/or (iv) an anaerobic radical scavenger as described herein. Preferably, the oxygen-curable precursor composition further comprises one or more additives, such as (v) a flame retardant, (vi) a surfactant, and/or (vii) a propellant.

As described above, in preferred embodiments, the reactive precursor mixture further comprises an unsaturated polyester resin (USPER) as described above, for instance dissolved in a reactive diluent, such as in 1,6 hexanediol diacrylate (1,6 HDDA) and/or tripropyleneglycol diacrylate (TPGDA). In foam applications, USPER compounds contribute to the foaming properties of the composition after dispensing, such as foam resilience, and also allow to reduce the price of the foam.

As described above, preferred radical initiator compounds included organometal or organoborane compounds. For example, triethyborane, methoxydiethyborane, tributyborane, and tri-sec-butylborane are preferred borane compounds. The organometal or organoborane initiator is preferably present in an amount comprised between 0.1 and 10 wt. %, with respect to the total weight of reactive precursor mixture, preferably between 0.1 and 6 wt. %, more preferably between 0.1 and 2 wt %.

As described above, an oxygen scavenger is particularly dissolved in the reactive precursor mixture. Advantageously, the presence of an oxygen scavenger ensures that, during storage, the composition remains anaerobic, i.e. that the oxygen content of the composition remains below 1 ppm, particularly or below 0.5 or 0.1 ppm and thus remains too low to react with the radical initiator compound, thus preventing the generation of radicals and the polymerization of the reactive precursor mixture.

As described above, the precursor composition may comprise further additives, including but not limited to rheology modifiers, plasticizers, flame retardants, crosslinkers, blowing agents, surfactants, tackifiers, colorants and the like.

In particular embodiments, the present invention relates to an oxygen-curable polymerizable foam precursor composition, particularly stored in a pressurized container, comprising (i) a reactive precursor mixture comprising a urethane and/or polyester (meth)acrylate and/or polyether (meth)acrylate compound with 1 to 6 vinyl moieties, preferably also an unsaturated polyester resin, and a diluent comprising a (meth)acrylate functionalized monomer with 1 to 4 vinyl moieties as further defined herein, (ii) a radical initiator, particularly an organometal or organoborane radical initiator as described herein, (iii) an oxygen scavenger; and, optionally (iv) an anaerobic radical scavenger, wherein the composition has an oxygen content of less than 1 ppm, preferably less than 0.5 or 0.1 ppm. In more particular embodiments, the oxygen-curable polymerizable foam precursor composition, particularly stored in a pressurized container, comprises a reactive precursor mixture comprising (a) an aromatic urethane (meth-)acrylates with 1 to 4 vinyl functional groups, preferably 1 to 3 vinyl functional groups, most preferably 1 to 2 vinyl functional groups; (b) an aliphatic urethane (meth-)acrylates with 3 to 6 vinyl functional groups, preferably 3 to 5, most preferably 3 to 4 vinyl functional groups, preferably (c) an unsaturated polyester resin and (d) a reactive diluent, comprising (meth)acrylated monomers with 1 to 4 vinyl functional groups. Advantageously, the acrylates or methacrylates functional groups block the generally toxic and harmful diisocyanates groups in the backbone of the (urethane) prepolymers. In certain embodiments, the oxygen-curable polymerizable foam precursor composition, particularly stored in a pressurized container, comprises a reactive precursor mixture comprising (i) an aliphatic urethane (meth-)acrylate blend comprising an aliphatic (meth)acrylate with 3 to 6 vinyl functional groups, preferably 3 to 5, most preferably 3 to 4 vinyl functional groups; and a fully (meth)acrylized monomeric aliphatic poly- or di-isocyanate; (ii) an aromatic urethane (meth-) acrylate blend, comprising an aromatic (meth)acrylate with 1 to 4 vinyl functional groups, preferably 1 to 3, most preferably 1 to 2 vinyl functional groups; and a fully (meth)acrylized monomeric aromatic poly- or di-isocyanate; (iii) a blend of reactive diluents, comprising monomers with 1 to 4 vinyl functional groups, preferably 1 to 3, most preferably 1 to 2 vinyl functional groups; (iv) an unsaturated polyester resin (USPER); (v) an oxygen scavenger; and (vi) preferably, one or more additives, such as an anaerobic radical scavenger, a surfactant, a flame retardant, and the like.

Specifically, the reactive compounds of the foam precursor composition are designed, prepared and combined, in order to inter alia (a) be able to undergo cross-linking polymerization to yield a final foam product resilience (upon oxygen mediated curing) with the necessary toughness, adhesion, mechanical and other properties for its respective field of application; (b) enable curing with sufficiently high speed and at sufficiently low temperatures to yield a final foam product with assigned quality; (c) not change physically and/or chemically during storage; (d) not release toxic products upon curing; and (e) enable high uniformity of the cell structure of the final foam product. Advantageously, the foam precursor compositions of the present application are a non-toxic alternative to the one component isocyanate—moisture curable polyurethane foams, with better design and enlarged area of potential use.

The foam precursor composition according to an embodiment of the present invention is preferably stored in a container, such as an aerosol can. The foam precursor composition is particularly in the form of a one component (1C) foam system, wherein the initiator and the reactive precursor mixture are not physically separated but in the same compartment in the container. Advantageously, as the composition only comprises traces of oxygen due to the different deoxygenation measures, the radical initiator can remain in contact with the reactive precursor mixture without enabling curing in the can. There is thus no need to microencapsulate the initiator compound, as it is inert in the absence of oxygen. Only upon spraying the composition out of the can through an aerosol nozzle, the organometal or organoborane initiator is activated by contact with oxygen and curing starts.

Another aspect of the present invention provides a container, optionally a pressurized container comprising a one component, oxygen curable precursor composition as described herein.

Another aspect of the present invention relates to the use of an oxygen curable precursor composition as described herein as a one component sprayable foam composition, a one component sealant or a one component adhesive.

The present invention is further illustrated with the following non-limiting illustrative embodiments.

### EXAMPLES

### Example 1: Experimental Determination of the Required Amount of Oxygen Scavenger

In an exemplary embodiment of the present invention, the amount of oxygen scavenger in the reactive precursor mixture, which ensures a good shelf life of the foam precursor composition, particularly when stored in a (pressurized) container, while, at the same time does not affect the curing rate of the foam precursor composition after dispensing, is determined experimentally.

To this end, a series of foam precursor compositions, particularly a series of (pressurized) containers comprising the foam precursor compositions, are prepared. Each container contains the same deoxygenated reactive precursor mixture (comprising the reactive oligomers and monomers, and, optionally, any desired additive), but a different amount of the oxygen scavenger. After filling the containers with the deoxygenated reactive precursor mixture and the oxygen scavenger, the containers are (temporarily) closed by valves, under an oxygen-free atmosphere (e.g. via an Anaerobic Glove Box). The prepared containers are then shaken for a time, sufficient for the reaction between the remaining oxygen in the deoxygenated reactive precursor mixture and the oxygen scavenger to be completed. Next, the same amount of an organoborane initiator compound is added to each container, wherein the amount of the initiator provides an optimal curing rate of the reactive precursor (as determined previous to the experiment). Finally, the containers are closed by the valves and a propellant is added under inert atmosphere. Typically, two identical series of containers are prepared, wherein a first series is used for assessing the curing rate and foam properties (cell structure, shrinkage & adhesion) of the foam after dispensing, and a second series is used to assess the shelf life of the containers. The containers which provide a good curing of the foam upon dispensing and have an optimal shelf life define the amount of oxygen scavenger which need to be added to the reactive precursor mixture. If none of the containers provide satisfactory foam quality or shelf life, the amount of oxygen scavenger to be added to the reactive precursor mixture can be increased or decreased, or the characteristics of the deoxygenation treatment can be changed, e.g. by applying a deeper vacuum and/or increasing the vacuum treatment time.

### Example 2: Preparation of an Aerosol Container Comprising a Foaming Compostion

In another exemplary embodiment of the present invention, the preparation of an aerosol container comprising a foaming composition according to the present invention is considered, comprising the following steps.

1. Providing all reactive components, additives and the organoborane initiator for the preparation of the foaming composition to the production site. At the production site, the reactive precursor mixture is prepared and conditioned prior to the addition of the oxygen scavenger and organoborane initiator in the course of the container filling procedure.

2. Initial preparation of the reactive precursor mixture (prior to the deoxygenation) by mixing the following components:
Urethane (Meth-)acrylates from all foreseen types; dissolved in the reactive diluents of the reactive precursor mixture: reactive diluents, for dissolving the Urethane (Meth-)acrylates and USPER. The reactive diluent may comprise a blend of monomers with 1 to 4 vinyl functional groups, preferably 1 to 3, most preferably 1 to 2 vinyl functional groups. Preferably, the reactive diluent blend comprises (meth-)acrylic esters of polyols, particularly a blend of 1,6 hexanediol diacrylate (1,6 HDDA), tripropyleneglycol diacrylate (TPGDA), iso-bomyl methacrylate (iBoMA) and/or 2-ethylhexyl methacrylate (2-EHMA), most preferably a blend of TPGDA and 2-EHMA. The urethane (mhat)acrylates may be separately prepared, as further illustrated below;
providing or preparing an unsaturated polyester resin (USPER), particularly comprising the synthesis of USPER via methods known in the art, and further dilution of the obtained USPER in the reactive monomeric diluents (instead of the usual styrene);
additives in the required amounts, including an anaerobic radical scavenger; a flame retardant, preferably TCPP.

3. Deoxygenation of the reactive precursor mixture, comprising several cycles of degassing by vacuum treatment followed by purging with an inert gas, in particular comprising from 4 to 8, preferably 4 to 6, such as 4 to 5 deoxygenation cycles, wherein each cycle comprises subjecting the reactive precursor mixture to a degassing vacuum treatment, and subsequently saturating or flushing the degassed reactive precursor mixture with an inert gas.

4. Deoxygenation of the surfactant, using a similar procedure as the deoxgenation of the reactive precursor mixture. The surfactant is preferably a silicone type surfactant, such as Tegostab 8870.

5. Transferring both the deoxygenated reactive precursor mixture and silicone surfactant into an inert atmosphere, with oxygen content of max. 5 ppm, preferably max 1 ppm, most preferably below 1 ppm. In lab conditions, an inert atmosphere can be created in an Anaerobic Glove Box in Lab condition. In commercial production conditions, the deoxygenated fluids are kept in containers under inert atmosphere.

6. Determination of the required level of organoborane initiator. In an anaerobic glove box, a certain amount of organoborane initiator is added to a small sample of the reactive precursor mixture mixed with the silicone surfactant. After mixing, the sample is taken out of the anaerobic Glove box in air and the time of fixing and accompanying max. temperature of the cross-linking polymerization are measured. The experiment is repeated with varying amounts of organoborane initiator, until the duration of the curing time ranges between 10 and 25 min, preferably between 12 and 20 min, most preferably between 15 and 18 min;

7. Determination of the standard level of oxygen scavenger with max. permissible deviations, applicable for all aerosol containers filled with the same reactive precursor mixture, which has been deoxygenated in the same procedure by the same equipment. In an anaerobic glove Box, a series of cans, preliminarily thoroughly flushed with an inert gas, are filled with the deoxygenated reactive precursor and deoxygenated surfactant. Next, a different amount of oxygen scavenger, defining a specific concentration range, is added to the cans. Each can is then temporarily closed with a valve and left to stay for a time sufficient for the complete reaction of the oxygen scavenger with the remaining oxygen in the reactive precursor mixture. Next, in the anaerobic glove box, the necessary amount of the organoborane initiator is added to each can (determined in accordance with pt 6) and the cans are filled by the required blowing agents. After storage, the curing time and foam quality is evaluated, and those aerosol cans combining a good shelf life, with a good foam quality and agood curing time define the optimal concentration range of oxygen scavenger for the reactive precursor mixture and related equipment under consideration.

8. Based on the amount of initiator and oxygen scavenger determined in pt 6 and 7, the preparation of the aerosol cans is completed under inert atmosphere. Particularly, in a commercial production facility, the filling of the aerosol cans is essentially similar to a filling line for filling traditional PU aerosol containers, but adapted to work in an anaerobic regime. In particular, three anaerobic operating systems are implemented, connected by anaerobic tunnels to transport the filling can (from one system to another):
system 1: empty containers are flushed by an inert gas to less than 5 ppm oxygen, preferably 1 ppm, most preferably less than 1 ppm;
system 2, where the flushed cans are filled with the reactive precursor mixture plus any additions, including the required amount of an oxygen scavenger (as determined in pt 7), as well as with the deoxygenated silicone surfactant. In the same system, the containers are closed by valves and filled with the blowing agent(s). Preferably, after system 2, the filled cans are typically stored (in normal atmosphere) for a period of about 4 hours, preferably 3 hours, most preferably less than 2 hours, so that the oxygen scavenger can react with the available oxygen in order to obtain fully anaerobic conditions in the can;
system 3, where the organoborane compound is introduced in the aerosol can by injecting it through a gas burette under pressure of inert gas (similar to the burette filling of the blowing agent).

It is understood that a producer of non-isocyanate foams does not have to implement drastic changes in its production facilities, particularly in the final steps thereof, in comparison to filling PU foams. Advantageously, there are no reactions taking place in the aerosol can, unlike as in the case of PU foams, except for the reaction of the oxygen scavenger with the oxygen traces, but this reaction has an ignorable thermal effect.

### Example 3: Preparation of a Reactive Precursor Mixture for an Isocyanate-Free Foaming Composition

In certain embodiments, Example 2, pt 1 comprises the step of preparing the reactive precursor mixture.

(a) The reactive precursor mixture may comprise an aromatic urethane (meth-)acrylate blend comprising a blend of reaction products of an aromatic polyisocyanate, particularly an aromatic diisocyanate, particularly a partially meth(acrylized) aromatic polyisocyanate, and an alcohol or polyol, wherein all isocyanate groups are blocked by a (meth)acrylate moiety. Particularly, said aromatic urethane (meth-)acrylate blend comprises a blend of an aromatic urethane (meth)acrylate, a fully acrylized aromatic polyisocyanate, such as a double acrylized monomeric aromatic diisocyanate, e.g. monomeric MDI, and a suitable reactive monomeric diluent. Advantageously, the aromatic urethane (meth-)acrylates as described herein contribute to a higher reactivity of the precursor mixture and contribute to the resilience of the final foam product.

In particular, the reactive precursor mixture comprises an aromatic urethane acrylate and/or urethane methacrylate blend, which is configured for use in an isocyanate-free foamable composition. In particular, the aromatic urethane acrylates and/or methacrylates blend comprises a blend of (i) fully (meth)acrylized NCO-terminated prepolymers or oligomers, which are the reaction products of an aromatic diisocyanate, preferably monomeric MDI, and suitable alcohol(s) with 1 to 2 hydroxyl groups, preferably one hydroxyl group, and (ii) a double (meth)acrylized aromatic diisocyanate, wherein all isocyanate groups are blocked by a (meth)acrylate moiety, particularly a hydroxyl(meth)acrylate moiety. In particular embodiments, the aromatic urethane(meth)acrylate blend comprises a blend of (i) fully (meth)acrylized NCO-terminated prepolymers or oligomers, which are the reaction products of an aromatic diisocyanate, preferably monomeric MDI, with a mono-functional alcohol with a branched aliphatic chain, preferably 2-ethyl hexanol, which is (meth)acrylized by a hydroxyalkyl(meth)acrylate, such as hydroxypropyl methacrylate (HPMA), or 2-hydroxyethyl acrylate (2-HEA), and (ii) a double acrylized monomeric diisocyanate, preferably double acrylized monomeric MDI. Preferably, the double acrylized monomeric MDI comprises the same (meth)acrylate moieties as the monofunctional alcohol. Advantageously, this urethane metacrylate blend composition has a low viscosity, a prolonged shelf life and is not expensive to produce.

The preparation of an aromatic urethane (meth)acrylate may thus comprise two steps (i) the reaction between a NCO-bifunctional aromatic isocyanate and a hydroxy(meth)acrylate to obtain a NCO-monofunctional aromatic isocyanate derivative and a double (meth)acrylized aromatic isocyanate; (ii) reacting the reaction product of step (i) with an alcohol or polyol, particularly an alcohol with 1 or 2 hydroxyl groups.

More in particular, in step (i), the aromatic diisocyanate, preferably MDI, is reacted with a hydroxy(meth)acrylate, preferably HEMA or HPMA, in particular using a suitable catalyst such as dibutyltin dilaurate. The amount of (meth)acrylate added is sufficient to react with at least half of the isocyanate groups of the aromatic diisocyanate, so that they are blocked with a (meth)acrylate moiety. It is thus understood that in step (i) also a certain amount of a double (meth)acrylized aromatic diisocyanate (MDI) is formed. For instance, after step (i), between 10 and 80%, such as between 20 and 60%, or between 20 and 50% of the MDI is converted to double (meth)acrylized MDI. To avoid allophanates formation, the reaction temperature is below 55° C., such as about 50° C. To this end, preferably, the required amount of hydroxyl(meth)acrylate, preferably HPMA is added stepwise. Additionally, an inert gas atmosphere is preferably maintained over the reaction mixture to prevent accidental contamination of the reaction medium with water. Step (i) continues up to the full exhaustion of the hydroxy(meth-)acrylate, such as HPMA, in the reaction.

In step (ii), the reaction product of step (i), i.e. a mono-NCO terminated prepolymer reaction product between the aromatic diisocyanate and the hydroxyl(meth)acrylate, is further reacted with an alcohol compound comprising 1 or 2 hydroxylgroups, preferably 1 hydroxyl group, such as 2-ethyl hexanol. Preferably, to avoid that non-reacted NCO groups remain after step (ii), the alcohol is added in excess. The reaction of step (ii) should continue until no free NCO groups can be detected in the reaction medium. In the second step, the fully acrylized diisocyanate from the first step, is present as inert component

An illustrative example of the preparation of an aromatic urethane (meth-)acrylate blend as envisaged in this section (a) of example 3 is as follows.

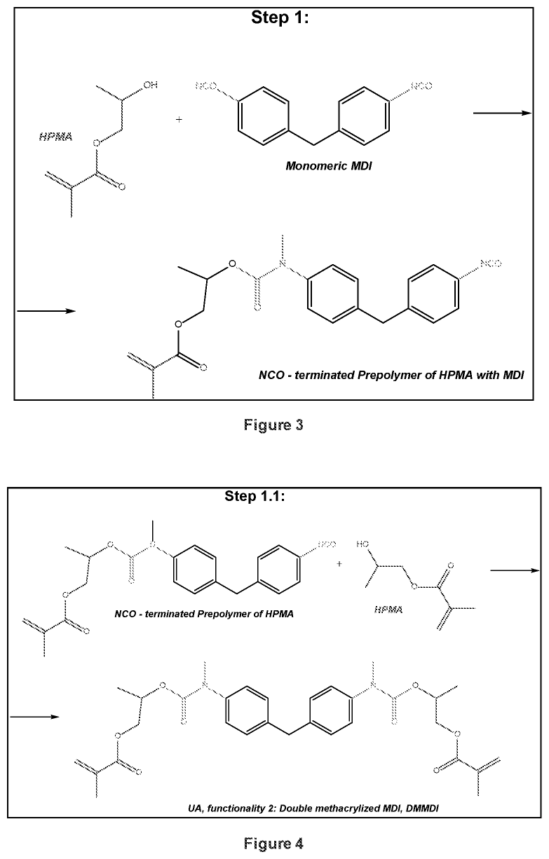

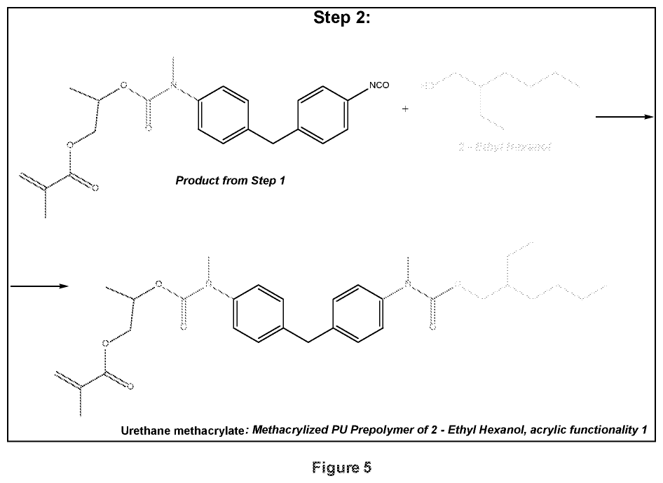

In a well stirred, hermetically closable, jacketed glass laboratory reactor with bottom valve, with a capacity of 2 l and equipped with a controllable heating/cooling system, 275.19 g of MDI (Suprasec 2004) is added and diluted with a blend of 78.75 g of 2-ethyl hexyl methacrylate, 78.75 g of iso-bornyl methacrylate and 157.5 g of tripropylene glycol diacrylate. An inert gas is passed in bubbles (2-3 per second) through the mixture under stirring. A triphenyl phosphite stabilizer (3.6 g) and di-butyltin laurate catalyst (0.27 g) are additionally added to the mixed medium. The reactor is warmed up to a temperature of 40° C. and then, via a dividing funnel, 230.53 g of hydroxypropyl methacrylate are added dropwise (for about 15 min), taking care that the temperature of the reactor does not increase to over 50° C. After all HPMA is introduced, the reaction continues under the created thermodynamic and mass—exchange conditions up to full reaction of HPMA (according to the reaction scheme shown in FIGS. 3 and 4), which at a temperature of about 50° C. takes about 3 hours. Next, at the same temperature, 79.28 g of 2-ethylhexanol are added to the reaction medium at once and the process continues under the same conditions (the temperature is kept at ±1° C.) until no NCO-groups remain in the reaction medium (at a temperature of about 55° C. this takes about 3 hours) (see reaction scheme presented in FIG. 5). Next, the reactor is emptied without cooling. The obtained blend of aromatic urethane methacrylate (about 900 g), contains about 45% double methacrylized MDI and the remainder comprises an aromatic urethane acrylate of 2-ethylhexanol. The blend is a slightly yellow, transparent liquid, which is able to cure by radical initiation, for example when contacted with 1% benzoyl peroxide and 0.2% di-methyl p-toluidine, in about 20 min at a maximum temperature of about 65° C.

(b) The reactive precursor mixture may comprise an aliphatic urethane (meth-)acrylate blend comprising a blend of reaction products of an aliphatic polyisocyanate, particularly an aliphatic diisocyanate, particularly a partially meth(acrylized) aliphatic polyisocyanate, and an alcohol or polyol, particularly an alcohol with between one or two and six hydroxyl groups, preferably three or four hydroxyl groups, wherein all isocyanate groups are blocked by a (meth)acrylate moiety. Particularly, said aliphatic urethane (meth-)acrylate blend comprises a blend of an aliphatic urethane (meth)acrylate, a fully acrylized aliphatic polyisocyanate, such as a double acrylized monomeric aliphatic diisocyanate, e.g. monomeric IPDI, and a suitable reactive monomeric diluent. Aliphatic urethane (meth-)acrylates contribute to a high cure speed at low temperatures, to the resilience of the final foam product, to the toughness and dimensional stability of the foam body and to the adhesion of the final foam product to various substrates.

In particular, the reactive precursor mixture comprises an aliphatic urethane acrylate and/or urethane methacrylate blend, which is configured for use in an isocyanate-free foamable composition. In particular, the aliphatic urethane acrylates and/or methacrylates blend comprises a blend of (i) fully (meth)acrylized NCO-terminated prepolymers or oligomers, which are the reaction products of an aliphatic diisocyanate, preferably Isophorone Diisocyanate or IPDI, and suitable polyols with 3 to 6 hydroxyl groups, preferably 3 to 5, most preferably 3 to 4 hydroxyl groups, and (ii) a double (meth)acrylized aliphatic diisocyanate, wherein all isocyanate groups are blocked by a (meth)acrylate moiety, particularly a hydroxyl(meth)acrylate moiety. In particular embodiments, the aromatic urethane(meth)acrylate blend comprises a blend of (i) fully (meth)acrylized NCO-terminated prepolymers or oligomers, which are the reaction products of an aliphatic diisocyanate, preferably IPDI, with a polyol, particularly a blend of glycerol and pentaerythritol, such as a blend of 60-70% glycerol and 30-40% pentaerythritol, which are (meth)acrylized by hydroxy(meth-)acrylate, hydroxypropyl methacrylate (HPMA), or 2-hydroxyethyl acrylate (2-HEA); and (ii) a double acrylized aliphatic diisocyanate, preferably double acrylized IPDI. Preferably, the double acrylized aliphatic diisocyanate comprises the same (meth)acrylate moieties as the polyols.

The preparation of an aliphatic urethane (meth)acrylate thus comprises two steps (i) the reaction between a NCO-bifunctional aliphatic isocyanate and a hydroxy(meth)acrylate to obtain a NCO-monofunctional aliphatic isocyanate derivative and a double (meth)acrylized aliphatic isocyanate; (ii) reacting the reaction product of step (i) with a polyol, particularly a polyol comprising between 3 to 6 hydroxyl groups, preferably 3 to 5, most preferably 3 to 4 hydroxyl groups. Preferably, the hydroxy(meth-)acrylate, as well as polyols have branched hydrocarbon chains in their chemical structure.

More in particular, in step (i), an aliphatic diisocyanate, preferably IPDI, is reacted with a hydroxy(meth)acrylate, preferably HEMA or HPMA, in particular using a suitable catalyst such as dibutyftin dilaurate. The amount of (meth)acrylate added is sufficient to react with at least half of the isocyanate groups of the aliphatic diisocyanate, so that they are blocked with a (meth)acrylate moiety. It is thus understood that in step (i) also a certain amount of a double (meth)acrylized aliphatic diisocyanate (IPDI) is formed. For instance, after step (i), between 10 and 80%, such as between 20 and 60%, or between 20 and 50% of the IPDI is converted to double (meth)acrylized IPDI. To avoid allophanate formation, the reaction temperature is below 60° C., such as about 55° C. or about 50° C. To this end, preferably, the required amount of hydroxyl(meth)acrylate, preferably HPMA is added stepwise. Additionally, an inert gas atmosphere is preferably maintained over the reaction mixture to prevent accidental contamination of the reaction medium with water. Step (i) continues up to the full exhaustion of the hydroxy(meth-)acrylate, such as HPMA, in the reaction.

In step (ii), the reaction product of step (i), i.e. a mono-NCO terminated prepolymer reaction product between the aliphatic diisocyanate and the hydroxyl(meth)acrylate, is further reacted with a polyol, particularly a glycerol/pentaerythritol mixture comprising about 30-40% pentaerythritol, such as about 35% pentaerythritol. Preferably, to avoid that non-reacted NCO groups remain after step (ii), the polyol or polyol mixture is added in excess. The reaction of step (ii) should continue until no free NCO groups can be detected in the reaction medium. In the second step, the fully acrylized diisocyanate from the first step, is present as inert component.

An illustrative example of the preparation of an aliphatic urethane (meth-)acrylate blend as envisaged in this section (b) of example 3 is as follows.

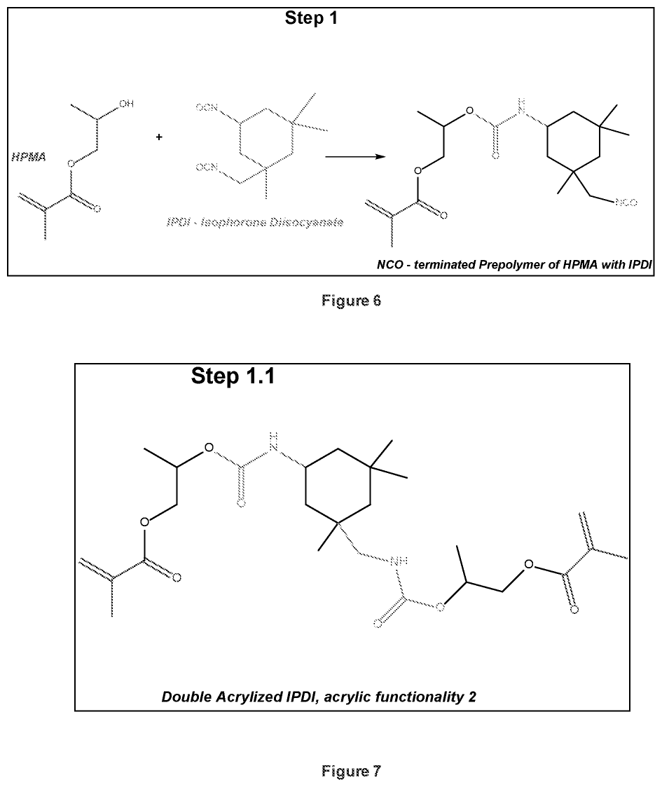

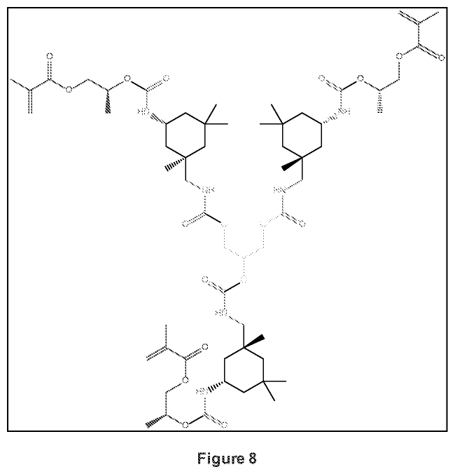

In a well stirred, hermetically closable, jacketed glass Laboratory reactor with a bottom valve, with a capacity of 2 l and equipped with a controllable heating/cooling system, 307.07 g Isophorone Diisocyanate (IPDI) is added and diluted with a blend of 78.75 g of 2-ethyl hexyl methacrylate, 78.75 g of iso-bornyl methacrylate and 157.5 g of tripropylene glycol diacrylate. An inert gas is passed in bubles (2-3 per second) through the mixture under stirring. A triphenyl phosphite stabilizer (3.6 g) and di-butyltin laurate catalyst (0.54 g) are additionally added to the mixture. The reactor is warmed up to a temperature of 45° C. and then, via a dividing funnel, 242.72 g of HPMA is added dropwise (for about 15 min), taking care that the temperature of the mixture does not increase to over 55° C. After all HPMA is introduced, the reaction continues under the created thermodynamic and mass—exchange conditions up to full reaction of HPMA (according to the reaction scheme presented in FIG. 6 and obtaining a double methacrylized IPDI as shown in FIG. 7) (at a temperature of about 55° C. this takes about 3.5 hours). Next, at the same temperature, 24.64 g of glycerol (minimum moisture content) and 10.56 g. of pentaerythritol are added to the reaction medium at once and the process continues under the same conditions (the temperature is kept ±1° C.) until no NCO-groups remain in the reaction medium (at a temperature of 55° C. (this takes about 3 h) (with glycerol, the structure shown in FIG. 8 is obtained). Next, the reactor is emptied without cooling. The obtained blend of aliphatic urethane acrylate (about 900 g) contains about 25% double methacrylized IPDI and the remainder comprises an aliphatic urethane acrylate prepolymer of a pentaerythritol/glycerol mixture with 30% pentaerythritol. The blend is a colourless, transparent liquid, which is able to cure by radical initiation, for example, when contacted with 1% benzoyl peroxide and 0.2% di-methyl p-toluidine, in about 12 min. at a maximum temperature of about 65° C.

### Example 4: Further Examples of Reactive Precursor Compositions for an Isocyanate-Free Foaming Composition

In a typical preparation of a foam aerosol can, the components of the reactive precursor mixture are mixed and subsequently degassed/deoxygenated according to the physical deoxygenation procedure. The same procedure is followed for the surfactant. The samples are placed in an anaerobic chamber with residual level of oxygen of 0.9 ppm. After 1 day, the deoxygenated reactive precursor mixture and surfactant are transferred to an aerosol container in the anaerobic chamber. The required volume of a borane-THF mixture is added to the aerosol containers and the composition is mixed. One hour after mixing, the required volume of alkylborane such as triethylborane or tributylborane is added to the aerosol cans, which are subsequently clinched. Next, cans are removed from the anaerobic chamber and filled with propellant. Foam cans are sprayed after 1 hour to evaluate curing and foam quality.

A/ An example of a formulation according to the present invention is shown in the following table 1 (expressed as part by weight (PBW) or wt % (expressed vs the total weight of the composition).

TABLE 1

| Component | PBW | wt % |
|---|---|---|
| Aliphatic Urethane Methacrylate f3/f4 | 29 | 25.9 |
| Aromatic Urea Methacrylate | 19 | 17.0 |
| Aromatic Urethane Methacrylate Biobased | 30.5 | 27.2 |
| Aromatic Urethane Methacrylate | 20 | 17.9 |
| TPGDA + Nitrosobenzene | 1.5 | 1.3 |
| TCPP Acid Stock Solution | 4 | 3.6 |
| TCPP | 4 | 3.6 |
| B8870/Coconut | 1 | 0.9 |
| B8870 | 3 | 2.7 |

A first illustrative example of an urethane methacrylate (UMA) is synthesized from isophorone diisocyanate (IPDI), pentaerythritol and glycerol, acrylized by hydroxyethylmethacrylate with functional distribution 3 to 4 of 65% and 35%. Double acrylized IPDI makes 25% of all UMA, reactive diluent is 35% of total product, Tegostab B8870 is a silicone surfactant with MW˜2600 and an average hydroxyl number of 60. Diethylamine condensed coconut oil (DEA/Coconut Oil or cocamide diethanolamine) is a surfactant partly composed of renewable resources. Tripropylene glycol diacrylate monomer (TPGDA) is a typical cross-linking agent with functionality 2. Tris(chloroisopropyl)phosphate (TCPP) is added as a flame retardant.

To this formulation is added the following scavenger and initiator (shown in Table 2), according to the protocol above.

TABLE 2

| Component | Volume |
|---|---|
| Diborane | 1.5 mL |
| Triethylborane | 3.5 mL |
| Tributylborane | 3.5 mL |
| LPG 4.7 | 25.4 mL |

B/ Another illustrative example is shown in Table 3. The composition is composed of an urethane methacrylate (UMA), aliphatic TMP, which is composed of a blend of 75% UMA and 25% double methacrylized IPDI. The UMA consists of 60% UMA synthesized from the reaction of trimethylol with diisocyanate (IPDI) and acrylized by hydroxypropylmethacrylate (functional acrylate distribution 3) and 40% UMA synthesized from diisocyanate (IPDI) reacted with trimethylol propane, subsequent reaction with IPDI, then acrylized by hydroxypropylmethacrylate (functional acrylate distribution 4). The Urea-Urethane (MA), Aromatic H, NPG/DEA is a blend of 75% Urea-Urethane MA aromatic and 25% double methacrylized mMDI. Urea MA, aromatic, D 2-EHA is a blend of 75% Urea MA aromatic and 25% double methacrylized mMDI. Cross-linking occurs by polypropylene glycol diacrylate, monomer, f=2 (Mw 700).

TABLE 3

| Component | PBW | wt % |
|---|---|---|
| UMA TMP, aliphatic | 19 | 18.3 |
| Urea MA D 2-EHA, aromatic | 29 | 28.2 |
| UMA NPG/GLY, aromatic H | 35 | 32.4 |
| UMA 2-EH, aromatic L | 7 | 6.9 |
| PPG700DA | 7 | 6.9 |
| TPGDA + Nitroso-benzene | 3 | 2.9 |
| TCPP | 4 | 3.1 |
| B8870 | 3 | 2.9 |

The structure/composition of these components is shown below. *UMA TMP, aliphatic

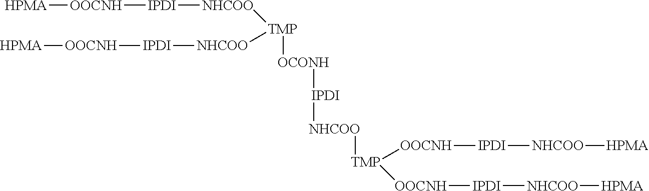

Aliphatic UMA f=4 (40% of f3+f4, hyper branched)

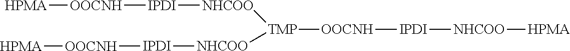

Aliphatic UMA f=3 (60% of f3+f4)

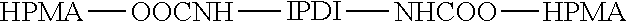

Double Methacrylized IPDI (IPDI DMA)

* Urea MA D 2-EHA, Aromatic

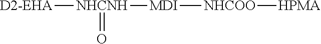

Aromatic Urea MA, f=1, 75% of Urea/Urethane MA

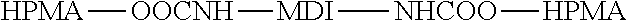

Double methacrylized mMDI (25% of Urea/Urethane MA)

* UMA NPG/GLY, Aromatic H

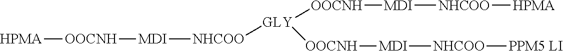

Aromatic UMA, f=3 (70% of f3+f2, GLY=Glycerol, PPM5 LI=Bisomer® Polypropyleneglycol Monomethacrylate)

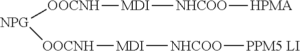

Aromatic UMA, f=2 (30% of f3+f2, NPG=Neopentyl Glycol)

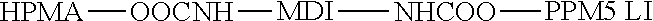

Double acrylized mMDI (25% of all amount of UMA in the blend)

*UMA, Aromatic, 2-EH L

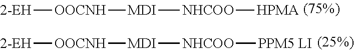

Aromatic UMA, f=1, 75% of UMA

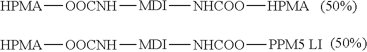

Double methacrylized mMDI (25%)

### Example 5: Foaming Performance

A foaming test was performed on a foaming composition, comprising 73 g of the formulation mixed with 4.6 g of surfactant, as prepared according to example described above. The effect of the borane (DB) used as an oxygen scavenger compound is investigated, with triethylborane (TEB) or tributhylborane (TBB) as radical initiators, according to the Table 4.

TABLE 4

| Test | A | B | C | D | E |
|---|---|---|---|---|---|
| DB | 2.5 mL | 1.5 mL | 1.0 mL | 0.5 mL | 1.0 mL |
| TEB | 0 | 2.0 mL | 2.0 mL | 1.0 mL | 3.5 mL |
| TBB | 2.5 mL | 0 mL | 0 mL | 0 mL | 0 mL |

Test A gave a stable foam body with fast surface cure, inside cure was complete after 45 minutes. Foam quality was affected by inhomogeneous cell structures. Test B gave a good quality foam with similar curing parameters as test A. Test C and D gave equal quality foams with lower level of oxygen scavenger. It was observed that more alkylborane resulted in harder foam with shorter full curing time (<40 min).

As a comparative example, to a typical formulation according to the above examples in an aerosol can, TEB was added without preceding addition of the borane oxygen scavenger.

Immediate reaction was observed by heating of the can typical of the exothermic curing reaction and foam spraying was not possible. A similar test with preceding addition of a borane-THF mixture gives an aerosol can that is still shakeable 3 h after filling. Foam spraying is possible and gives a fast curing foam according to above examples. Therefore, borane acts as a suitable oxygen scavenger and radical cure control agent.

1. A method for preparing a one component, oxygen-curable precursor composition, comprising:
(i) preparing or providing a reactive precursor mixture, wherein the reactive precursor mixture comprises at least one free-radically polymerizable monomer and/or oligomer;
(ii) subjecting the reactive precursor mixture to a deoxygenation treatment, thereby obtaining a deoxygenated reactive precursor mixture;
(iii) adding an oxygen scavenger to the deoxygenated reactive precursor mixture, and subsequently
(iv) adding an organometal or organoborane compound radical initiator to the deoxygenated reactive precursor mixture.

2. The method according to claim 1, wherein the reactive precursor mixture has a viscosity of at least 3500 cP.

3. The method according to claim 1, wherein the deoxygenation treatment comprises subjecting the reactive precursor mixture to one or more deoxygenation cycles, wherein each deoxygenation cycle comprises degassing the reactive precursor mixture by subjecting it to a vacuum and subsequently purging or flushing the degassed reactive precursor mixture with an inert gas.

4. The method according to claim 1, wherein the reactive precursor mixture comprises at least one ethylenically unsaturated compound having at least one free-radically polymerizable carbon-carbon double bond.

5. The method according to claim 4, wherein the at least one ethylenically unsaturated compound is a vinyl compound.

6. The method according to claim 5, wherein the reactive precursor mixture comprises a urethane and/or polyester (meth)acrylate compound with 1 to 6 vinyl moieties.

7. The method according to claim 1, wherein the reactive mixture further comprises at least one reactive diluent.

8. The method according to claim 1, wherein the organometal or organoborane compound is an alkyl- or alkoxy-metal or an alkyl- or alkoxyborane compound.

9. The method according to claim 1, wherein the reactive precursor mixture further comprises an anaerobic radical scavenger.

10. The method according to claim 1, wherein the reactive precursor mixture further comprises one or more additives.

11. The method according to claim 1, wherein the method further comprises filling a container with the deoxygenated reactive precursor mixture comprising an oxygen scavenger and, optionally, pressurizing the container by adding a blowing agent or propellant.

12. A one component, oxygen-curable precursor composition, obtainable by the method according to claim 1.

13. The oxygen-curable precursor composition according to claim 12, comprising;
a deoxygenated reactive precursor mixture, comprising at least one ethylenically unsaturated compound having 1 to 10 free-radically polymerizable carbon-carbon double bonds;
an oxygen scavenger; and
an organometal or organoborane compound as radical initiator
wherein the precursor composition comprises less than 1 ppm oxygen.

14. The oxygen-curable precursor composition according to claim 12, wherein the viscosity of the precursor composition is at least 3500 cP.

15. The oxygen-curable precursor composition according to claim 13,
wherein the deoxygenated reactive precursor mixtures comprises a urethane and/or polyester (meth)acrylate compound with 1 to 6 vinyl moieties and a diluent comprising a (meth)acrylate functionalized monomer with 1 to 4 vinyl moieties.

16. A container, comprising a composition according to claim 12.

17. A method of spraying, sealing, or adhering an object, comprising:
applying the composition according to claim 12 as a component sprayable foam composition, a component sealant, or a component adhesive to the object.

18. The method according to claim 4, wherein the at least one ethylenically unsaturated compound has 1 to 10 free-radically polymerizable carbon-carbon double bonds.

19. The method according to claim 5, wherein the vinyl compound is selected from the group consisting of an acrylate compound, a methacrylate compound, an allyl ether compound and a styrene compound.

20. The method according to claim 7, wherein the diluent comprises a free-radically polymerizable monomer having 1 to 4 unsaturated free-radically polymerizable groups or carbon-carbon double bonds.

21. The method according to claim 10, wherein the one or more additives are selected from the group consisting of a stabilizer, a flame retardant, a surfactant, a propellant, a blowing agent, and a colorant.
